(19) United States
(12) Patent Application Publication
(10) Pub. No.: US 2014/0067352 A1
(43) Pub. Date: Mar. 6, 2014

(54) PRESENTING ATTRIBUTES OF INTEREST IN A PHYSICAL SYSTEM USING PROCESS MAPS BASED MODELING

(71) Applicant: Intellicess Inc., Austin, TX (US)

(72) Inventor: Pradeepkumar Ashok, Austin, TX (US)

(73) Assignee: Intellicess Inc., Austin, TX (US)

(21) Appl. No.: 14/017,430

(22) Filed: Sep. 4, 2013

Related U.S. Application Data
(60) Provisional application No. 61/697,769, filed on Sep. 6, 2012.

(51) Int. Cl. G06F 17/50

(52) U.S. Cl. CPC G06F 17/5009
USPC 703/6

(57) ABSTRACT

A method, computer program product and system for presenting attributes of interest. A decision surface is created using process maps. The process maps are representative of system operational data from a plurality of sensors. A current operating point is identified including a location and a movement characteristic of the operating point. The location and the movement characteristic of the operating point are used to identify an attribute with a final probabilistic value assigned to the attribute. If the final probabilistic value for the attribute crosses a previously-defined threshold, an alarm is generated. The decision surfaces, the process maps, the current operating point, the predicted movement of the operating point, the attributes, and the alarms are visually represented in a data handling system to assist the operator in the real time monitoring and operation of the physical system.

### CROSS-REFERENCE TO RELATED APPLICATIONS

This application is related to the following commonly owned co-pending U.S. patent application:

Provisional Application Ser. No. 61/697,769, “Distinguishing Among Attributes in a Physical System Using Process Maps Based Modeling,” filed Sep. 6, 2012, and claims the benefit of its earlier filing date under 35 U.S.C. §119(e).

### TECHNICAL FIELD

The present invention relates to monitoring, diagnosing and condition-based maintenance of the real time operation of a physical system, and more particularly to presenting attributes of interest in a physical system (e.g., oil rig system) using process maps based modeling.

### BACKGROUND

Many physical systems need to be monitored in real time. One particular example of a physical system that needs to be modeled and monitored in real time is an oil rig system, where the failure to effectively model and monitor the oil rig system can lead to catastrophic accidents, such as an oil rig explosion. Presenting attributes of interest of the physical system (e.g., oil rig system) to a data handling system assists in the monitoring, diagnosing and condition-based maintenance of the system. When the attributes of the physical system, such as an oil rig system, are presented effectively and accurately to the data handling system, various oil rig operational states, such as tripping, reaming, slide-drilling, etc., and drilling events can be automatically identified to help detect hazardous as well as non-productive drilling situations, such as kick, lost circulation, stuck pipe incidents, etc., as well as help detect failing equipment, such as drill bits, top drive, blow out preventers, generators. etc., and thereby help mitigate risks and enhance efficiency associated with the operation of the system. Unfortunately, attributes of interest are not able to be effectively and accurately presented to the data handling system.

### BRIEF SUMMARY

In one embodiment of the present invention, a method for presenting attributes of interest in a physical system comprises identifying an attribute of the physical system. The method further comprises creating a decision surface using one or more of a plurality of process maps, where the one or more of the plurality of process maps are representative of system operational data from a plurality of sensors. Furthermore, the method comprises identifying a location and a movement characteristic of a current operating point, where the current operating point represents values of variables represented by one or more decision surfaces. Additionally, the method comprises using the location and movement characteristic to identify an attribute with a probabilistic value assigned to the attribute. The method further comprises generating a final probabilistic value for the identified attribute, where the final probabilistic value is obtained from weighting and combining probabilistic values. The method additionally comprises generating an alarm in response to the final probabilistic value for the identified attribute crossing a threshold. In addition, the method comprises visually representing the one or more of the plurality of process maps, the one or more decision surfaces, the identified attribute, the current operating point, a predicted movement of the current operating point, and the alarm in a data handling system to assist an operator in real-time monitoring and operation of the physical system.

Other forms of the embodiment of the method described above are in a system and in a computer program product.

The foregoing has outlined rather generally the features and technical advantages of one or more embodiments of the present invention in order that the detailed description of the present invention that follows may be better understood. Additional features and advantages of the present invention will be described hereinafter which may form the subject of the claims of the present invention.

### BRIEF DESCRIPTION OF THE SEVERAL VIEWS OF THE DRAWINGS

A better understanding of the present invention can be obtained when the following detailed description is considered in conjunction with the following drawings, in which:

FIG. 1 depicts an embodiment of a hardware configuration of a computer system in accordance with an embodiment of the present invention;

FIG. 2 is a flowchart of a method for creating a model of the system in accordance with an embodiment of the present invention;

FIG. 3 depicts examples of process maps and decision surfaces in accordance with an embodiment of the present invention;

FIG. 4 is a flowchart of a method for generating attributes for the system in real-time using the model developed in FIG. 2 in accordance with an embodiment of the present invention;

FIG. 5A is an example of a decision surface that is split into three distinct regions in accordance with an embodiment of the present invention;

FIG. 5B depicts some of the various shapes that can represent a region in accordance with an embodiment of the present invention;

FIG. 5C depicts a relation between the location of the operating point in the region and the probabilistic inference of the various attributes in accordance with an embodiment of the present invention;

FIG. 6A depicts another example of a decision surface where the movement characteristics are tracked in accordance with an embodiment of the present invention;

FIG. 6B illustrates how the movement as well as the rate of movement may be tracked for a particular decision surface in accordance with an embodiment of the present invention;

FIG. 6C illustrates an operating point path on a decision surface mapped onto to a two-dimensional (2D) plot with time on the x-axis in accordance with an embodiment of the present invention;

FIG. 7 illustrates an example of the Markov network that can be used to aggregate the location and movement characteristic information (also referred to as features) obtained from all the decision surfaces in accordance with an embodiment of the present invention;

FIG. 8 illustrates an example of a system to apply the techniques of the present invention in accordance with an embodiment of the present invention; and

FIG. 9 illustrates an example of multiple systems sending data to a central depository where the operator in the decision support system is informed of any systems that require attention and/or intervention in accordance with an embodiment of the present invention.

### DETAILED DESCRIPTION

In the following description, numerous specific details are set forth to provide a thorough understanding of the present invention. However, it will be apparent to those skilled in the art that the present invention may be practiced without such specific details. In other instances, well-known circuits have been shown in block diagram form in order not to obscure the present invention in unnecessary detail. For the most part, details considering timing considerations and the like have been omitted inasmuch as such details are not necessary to obtain a complete understanding of the present invention and are within the skills of persons of ordinary skill in the relevant art.

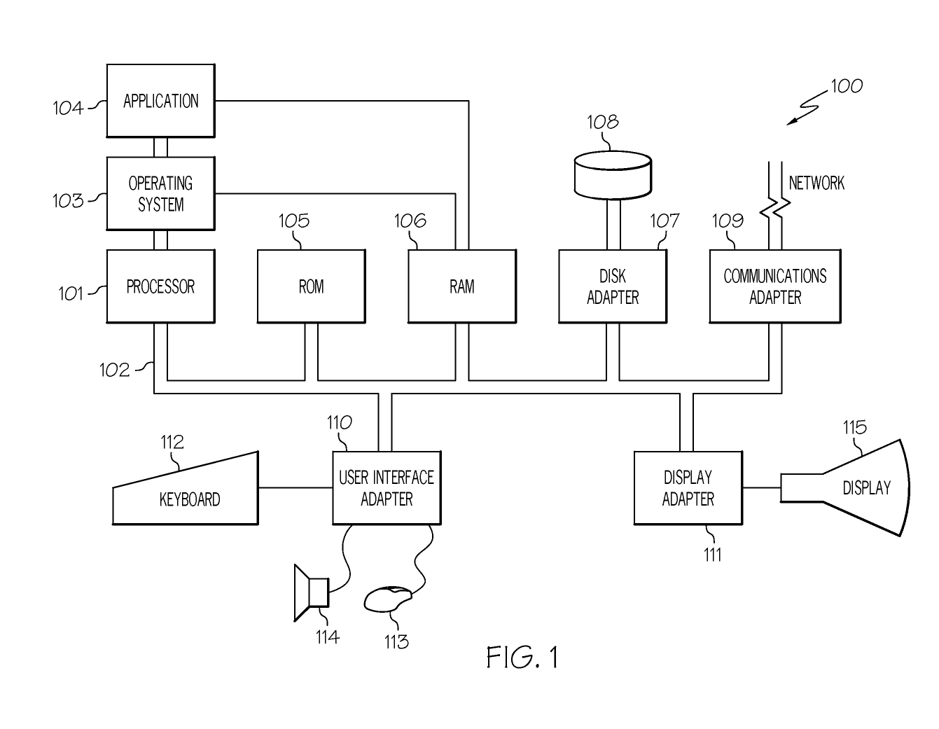

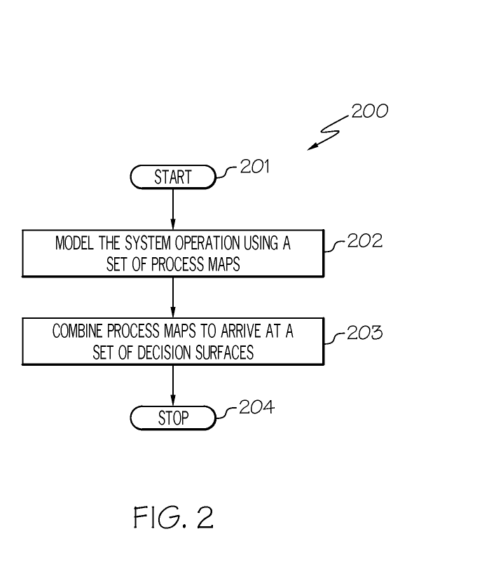

Referring now to the Figures in detail, FIG. 1 illustrates an embodiment of a hardware configuration of a computer system 100 which is representative of a hardware environment for practicing the present invention. In one embodiment, computer system 100 is attached to sensors (not shown), sensing activities, events, physical variables, etc., occurring in a physical system (e.g., oil rig system). Referring to FIG. 1, computer system 100 may have a processor 101 coupled to various other components by system bus 102. An operating system 103 may run on processor 101 and provide control and coordinate the functions of the various components of FIG. 1. An application 104 in accordance with the principles of the present invention may run in conjunction with operating system 103 and provide calls to operating system 103 where the calls implement the various functions or services to be performed by application 104. Application 104 may include, for example, an application for presenting attributes of interest in a physical system (e.g., oil rig system) using process maps as discussed further below in association with FIGS. 2-4, 5A-5C, 6A-6C, and 7-9.

Referring again to FIG. 1, read-only memory (“ROM”) 105 may be coupled to system bus 102 and include a basic input/output system (“BIOS”) that controls certain basic functions of computer device 100. Random access memory (“RAM”) 106 and disk adapter 107 may also be coupled to system bus 102. It should be noted that software components including operating system 103 and application 104 may be loaded into RAM 106, which may be computer system's 100 main memory for execution. Disk adapter 107 may be an integrated drive electronics (“IDE”) adapter that communicates with a disk unit 108, e.g., disk drive. It is noted that the program for presenting attributes of interest in a physical system using process maps, as discussed further below in association with FIGS. 2-4, 5A-5C, 6A-6C, and 7-9, may reside in disk unit 108 or in application 104.

Computer system 100 may further include a communications adapter 109 coupled to bus 102. Communications adapter 109 may interconnect bus 102 with an outside network (not shown) thereby allowing computer system 100 to communicate with other similar devices.

I/O devices may also be connected to computer system 100 via a user interface adapter 110 and a display adapter 111. Keyboard 112, mouse 113 and speaker 114 may all be interconnected to bus 102 through user interface adapter 110. Data may be inputted to computer system 100 through any of these devices. A display monitor 115 may be connected to system bus 102 by display adapter 111. In this manner, a user is capable of inputting to computer system 100 through keyboard 112 or mouse 113 and receiving output from computer system 100 via display 115 or speaker 114.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the C programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to product a machine, such that the instructions, which execute via the processor of the computer or other programmable data processing apparatus, create means for implementing the function/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the function/acts specified in the flowchart and/or block diagram block or blocks.

As stated in the Background section, many physical systems need to be monitored in real time. One particular example of a physical system that needs to be modeled and monitored in real time is an oil rig system, where the failure to effectively model and monitor the oil rig system can lead to catastrophic accidents, such as an oil rig explosion. Presenting attributes of interest of the physical system (e.g., oil rig system) to a data handling system assists in the monitoring, diagnosing and condition-based maintenance of the system. When the attributes of the physical system, such as an oil rig system, are presented effectively and accurately to the data handling system, various oil rig operational states, such as tripping, reaming, slide-drilling, etc., and drilling events can be automatically identified to help detect hazardous as well as non-productive drilling situations, such as kick, lost circulation, stuck pipe incidents, etc., as well as help detect failing equipment, such as drill bits, top drive, blow out preventers, generators. etc., and thereby help mitigate risks and enhance efficiency associated with the operation of the system. Unfortunately, attributes of interest are not able to be effectively and accurately presented to the data handling system.

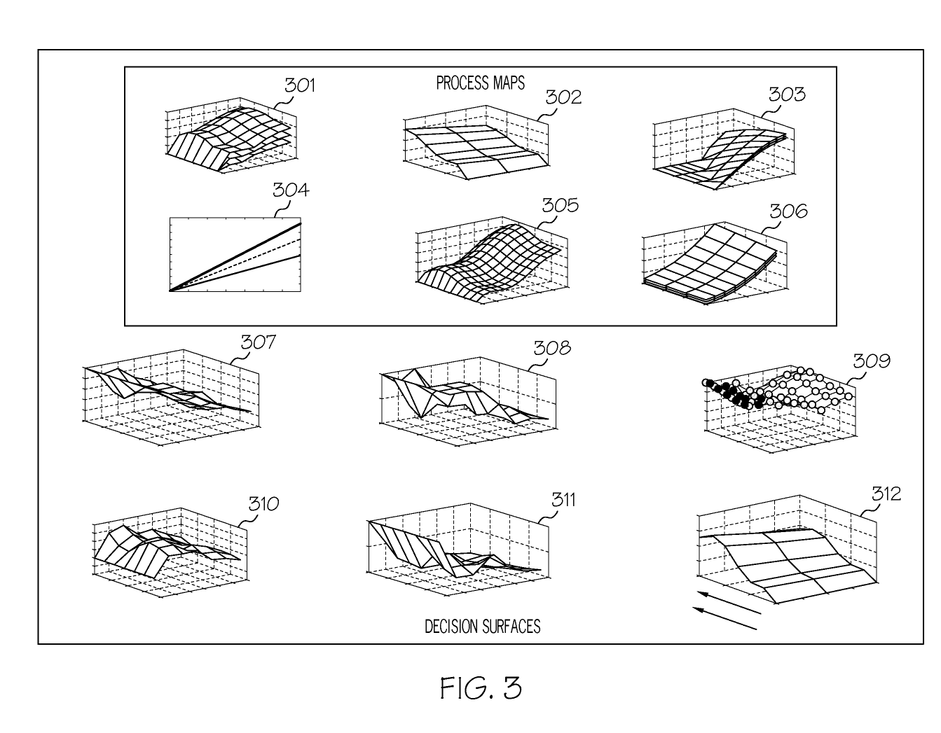

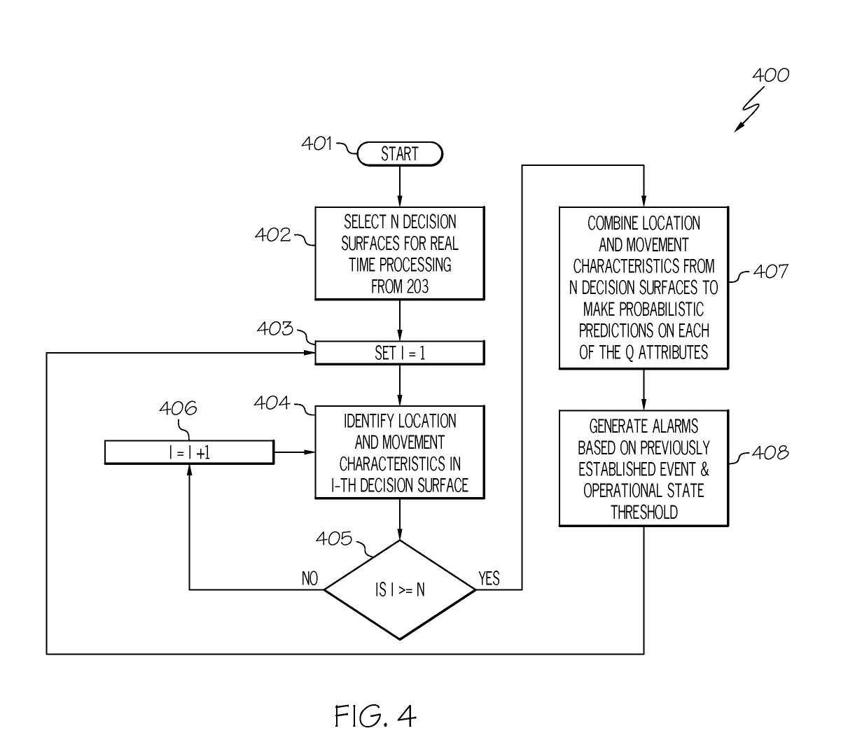

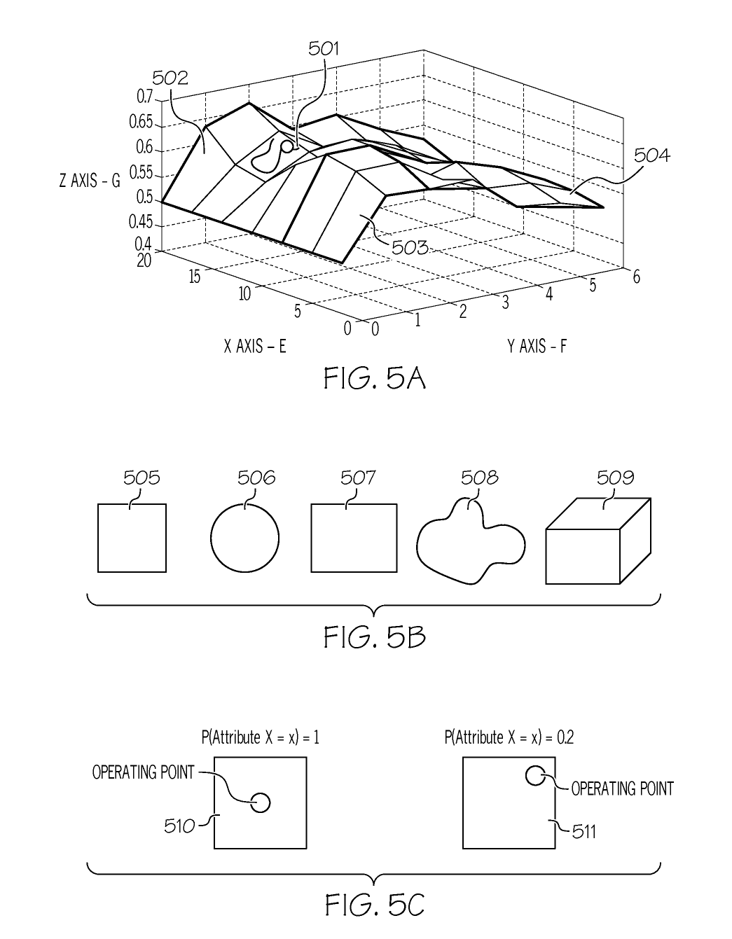

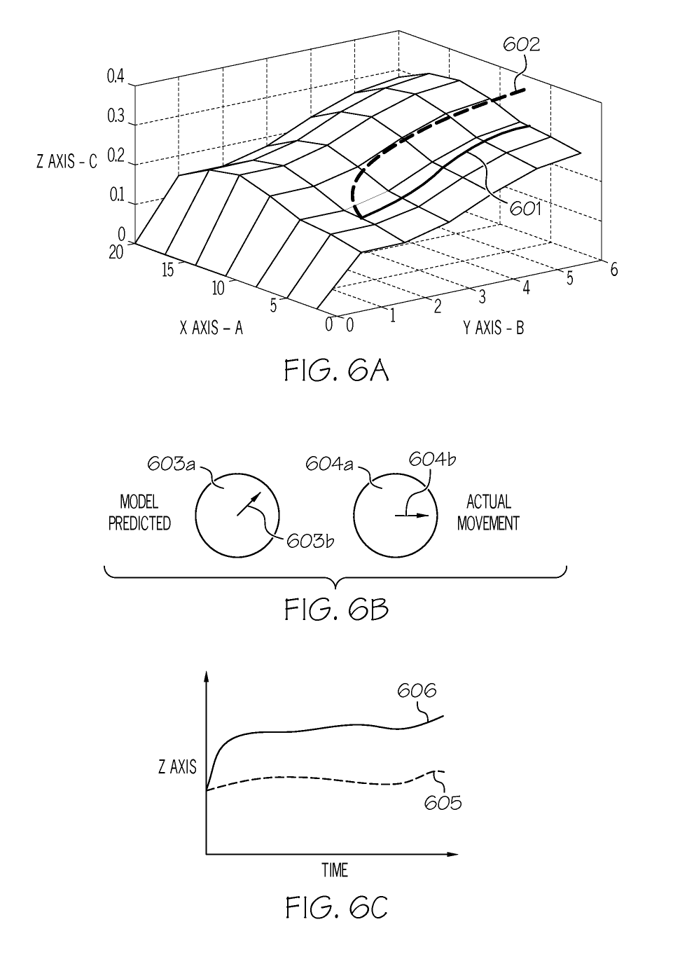

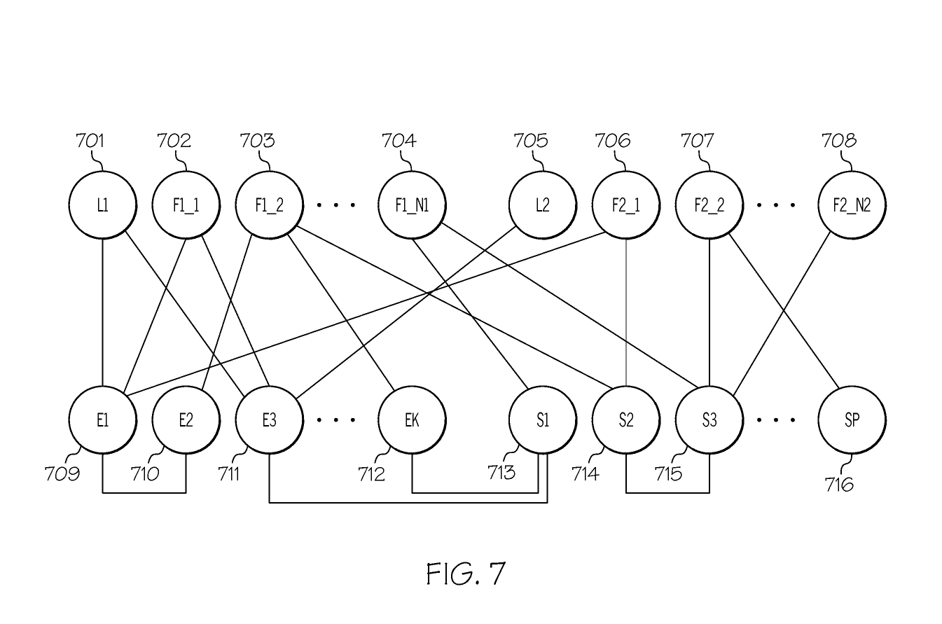

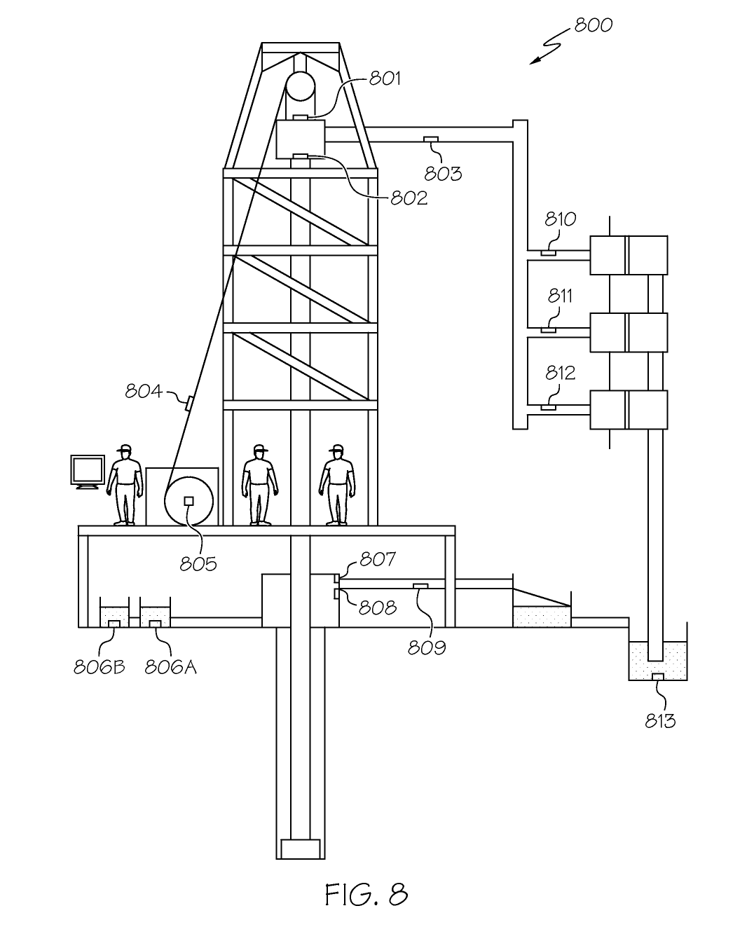

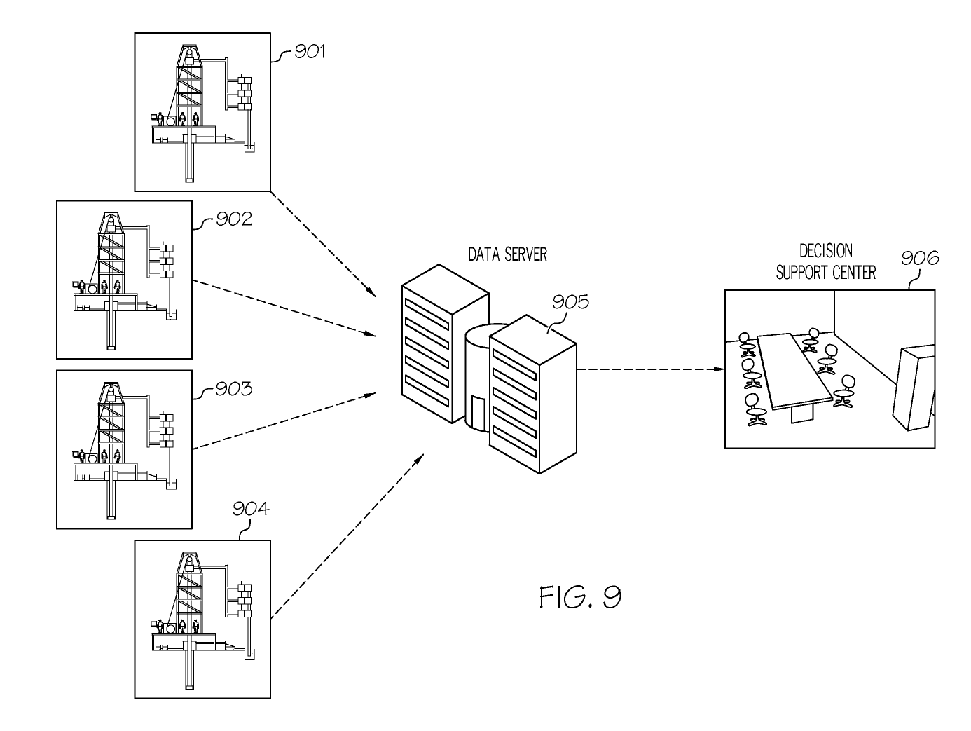

The principles of the present invention provide a means for effectively and accurately presenting attributes of interest in a physical system (e.g., oil rig system) using process maps as discussed below in association with FIGS. 2-4, 5A-5C, 6A-6C, and 7-9. FIG. 2 is a flowchart of a method for creating a model of the system. FIG. 3 depicts examples of process maps and decision surfaces. FIG. 4 is a flowchart of a method for generating attributes for the system in real-time using the model developed in FIG. 2. FIG. 5A is an example of a decision surface that is split into three distinct regions. FIG. 5B depicts some of the various shapes that can represent a region. FIG. 5C depicts a relation between the location of the operating point in the region and the probabilistic inference of the various attributes. FIG. 6A depicts another example of a decision surface where the movement characteristics are tracked. FIG. 6B illustrates how the movement as well as the rate of movement may be tracked for a particular decision surface. FIG. 6C illustrates an operating point path on a decision surface mapped onto to a two-dimensional (2D) plot with time on the x-axis. FIG. 7 illustrates an example of the Markov network that can be used to aggregate the location and movement characteristic information (also referred to as features) obtained from all the decision surfaces. FIG. 8 illustrates an example of a system to apply the techniques of the present invention. FIG. 9 illustrates an example of multiple systems sending data to a central depository where the operator in the decision support system is informed of any systems that require attention and/or intervention.

Referring now to FIG. 2, FIG. 2 is a flowchart of a method 200 for creating a model of the system in accordance with an embodiment of the present invention. In particular, method 200 shows the preprocessing steps that are preferably performed before the real time data processing starts. In step 201, the preprocessing steps of method 200 are started. In step 202, the system operation is modeled (modeling the predefined operational states of the system) using a set of process maps. Process maps are models (physics based and/or analytically or experimentally derived) that encode and represent one measurable parameter (also referred to as an output parameter) against other measurable parameters (also referred to as an input or control parameter). There can be more than one input or control parameter but only one output parameter in a process map. In one particular embodiment, process maps may represent the conditional probability table or conditional probability distribution of a Bayesian network as discussed in U.S. Patent Application No. 2012/0215450, which is hereby incorporated herein by reference in its entirety. In particular, these process maps may be stored as probability tables of modeled data between a particular operational variable and other operational variables.

Referring to FIG. 3, FIG. 3 depicts examples of process maps and decision surfaces in accordance with an embodiment of the present invention. Process maps 301, 302, 303, 305 and 306 are examples of process maps where the number of input or control parameters is 2. Process map 304 is an example of a process map where the number of input or control parameters is 1.

A system may have any number of process maps, where the number of process maps may depend on the number of the sensors in the system. i.e., the more the number of sensors, the more the number of process maps.

Returning back to FIG. 2, in conjunction with FIG. 3, in step 203, the process maps are combined to arrive at a set of decision surfaces. These combinations/modifications involve addition, subtraction, normalization, logical additions, etc. Process map combination is discussed in detail in Pradeepkumar Ashok and Delbert Tesar, “A Visualization Framework for Real Time Decision Making in a Multi-Input Multi-Output System,” IEEE Systems Journal, Vol. 2, Issue. 1, 2008; the entire content of which is incorporated herein by reference.

As illustrated in FIG. 3, decision surfaces 307 . . . 312 represent decision surfaces obtained by combining/modifying one or many of the process maps. It is noted that the process maps by themselves are also decision surfaces and FIG. 3 represents the process maps as being a subset of the decision surfaces. In other words, FIG. 3 can be considered to be depicting decision surfaces 301 . . . 312, of which the first six 301 . . . 306 are also process maps. The last six decision surfaces 307 . . . 312 are obtained by combining/modifying one or many of the six process maps. As a result, when the term “decision surface” is used herein, the term “decision surface” refers to both the process maps and the combined/modified surfaces.

In step 204, method 200 is ended.

In some implementations, method 200 may include other and/or additional steps that, for clarity, are not depicted. Further, in some implementations, method 200 may be executed in a different order presented and that the order presented in the discussion of FIG. 2 is illustrative. Additionally, in some implementations, certain steps in method 200 may be executed in a substantially simultaneous manner or may be omitted.

FIG. 4 is a flowchart of a method 400 for generating attributes for the system in real-time using the model developed in FIG. 2 in accordance with an embodiment of the present invention. In particular, FIG. 4 is a flowchart that shows the steps to use the decision surfaces generated at the end of FIG. 2 to generate appropriate alarms. Method 400 begins with step 401 followed by selecting, in step 402, a set of N decision surfaces from the full set of decision surfaces obtained at the end of FIG. 2. N may vary from 1 to all of the decision surfaces generated as a result of FIG. 2. In one embodiment, the subset of decision surfaces that will be used may be derived from the process faults identified using U.S. Patent Application No. 2012/0215450. Next, in step 403, the counter I is set to 1. In step 404, the location and movement characteristics in the I-th decision surface are identified as illustrated in FIGS. 6A-6C.

FIG. 6A depicts another example of a decision surface where the movement characteristics are tracked in accordance with an embodiment of the present invention. FIG. 6B illustrates how the movement as well as the rate of movement may be tracked for a particular decision surface. FIG. 6C illustrates an operating point path on a decision surface mapped onto to a two-dimensional (2D) plot with time on the x-axis.

Referring to FIG. 4, in conjunction with FIGS. 6A-6C, the movement characteristics which consist of the modeled 603B and actual 604B direction of movement of the operating point, the modeled 603A and actual 604A rate of movement of the operating point and the modeled 601, 605 and actual path 602, 606 of the operating point over a period of time are noted. It can be noted that the period of time of interest can be different for paths in different decision surfaces. This process is repeated for all N decision surfaces.

In step 405, a determination is made as to whether I is greater than or equal to N. If I is not greater than or equal to N, then I is incremented by one in step 406. Otherwise, the location and movement characteristics from the N decision surfaces are combined to make probabilistic predictions on each of the Q attributes in step 407. It is noted that each decision surface may contribute multiple movement characteristics including those in 601 . . . 606, and also combinations and modifications of the information obtained from 601 . . . 606. The complete set of such movement characteristics for all decision surfaces is also referred to as a feature set 702 . . . 704, 706 . . . 708 as shown in FIG. 7 in accordance with an embodiment of the present invention. A further discussion of FIG. 7 will be provided below.

FIG. 5A is an example of a decision surface that is split into three distinct regions 502, 503, 504, each region representing one or more multiple attributes, in accordance with an embodiment of the present invention. Referring to FIG. 5A, the regions do not have a specific shape. An alternate arrangement consists of dividing the same decision surface into a 4×6 grid with four intervals along the x-axis and six intervals along the y-axis. Each grid is then associated with some attributes, with the location of the operating point 501 within the grid providing a probabilistic measure of the attributes.

FIG. 5B depicts some of the various shapes 505, 506, 507, 508, 509 that can represent a region in accordance with an embodiment of the present invention. In particular, FIG. 5B illustrates that these regions that encompass the location of the operating point can have any arbitrary shape and also be multi-dimensional.

FIG. 5C depicts a relation between the location of the operating point in the region and the probabilistic inference of the various attributes in accordance with an embodiment of the present invention. In particular, FIG. 5C illustrates one embodiment of abstracting probabilistic measures based on the location of the operating point within the regions. As illustrated in Figure C, region 510 is a square box with the operating point at the center. In one embodiment, this results in P(Attribute X=x)=1, where the above equation may be read as the probability that x is some value that a particular attribute X can take is equal to 1. In region 511, the operating point is closer to the edge of the square box and hence the probability that the attribute X is equal to x is much smaller (0.2). For each region, functions can be developed to map the location of an operating point within the region to a probabilistic value for various attributes.

As discussed above, FIG. 6A depicts another example of a decision surface where the movement characteristics are tracked in accordance with an embodiment of the present invention. In particular, FIG. 6A illustrates the path taken by the operating point over a period of time. Referring to FIG. 6A, path 601 is the path that the operating point would take under a normal no fault operational condition. Path 602 is one example of a path that the operating point would take in case of a fault in the system. These paths or lines provide the movement characteristics that become inputs as features to the aggregation model as discussed further below in connection with FIG. 7. In one embodiment, the path taken by the operating point over a period of time may be mapped onto a circular plot to enable one to differentiate the direction and rate of change of the operating point between the model conditions 603A, 603B and the actual conditions 604A, 604B, as shown in FIG. 6B in accordance with an embodiment of the present invention. In another embodiment, the path may be mapped to a two dimensional plot with the x-axis representing time as shown in FIG. 6C in accordance with an embodiment of the present invention. Here, plot 605 depicts the line corresponding to normal operations and plot 606 depicts the line corresponding to a faulty operation. A supervised learning algorithm, such as logistic regression or neural network or support vector machines, may be used to classify such plots and to assign probabilistic values to the features it represents.

Returning to FIG. 4, as discussed above, the location and movement characteristics from all N surfaces are combined to arrive at final probabilities estimated for the various attributes of the system in step 407. These values are then used to generate appropriate alarms in step 408 based on previously defined thresholds. When multiple alarms are generated, a ranking scheme may be used to suitably and conveniently display in a preset order only those alarms that are safety and mission critical and help in bringing the system to normalcy. This will help alleviate the problem of alarm overload. Upon generating alarms in step 408, the counter I is set to 1 in step 403. As a result of step 408 looping back to step 403, method 400 is repeated continuously thereby providing real time continuous monitoring of the system.

In some implementations, method 400 may include other and/or additional steps that, for clarity, are not depicted. Further, in some implementations, method 400 may be executed in a different order presented and that the order presented in the discussion of FIG. 4 is illustrative. Additionally, in some implementations, certain steps in method 400 may be executed in a substantially simultaneous manner or may be omitted.

FIG. 7 illustrates an example of the Markov network that can be used to aggregate the location and movement characteristic information (also referred to as features) obtained from all the decision surfaces in accordance with an embodiment of the present invention. In particular,

FIG. 7 illustrates aggregating the location and movement characteristic information gathered from the N decision surfaces to arrive at probabilistic estimates for the attributes. This involves the construction of a probabilistic Markov network, where nodes of the Markov network correspond to the operation point locations 701, 705 and movement characteristics (features) 702 . . . 704, 706 . . . 708 of the N decision surfaces that are probabilistically linked to the various attributes 709 . . . 716. Operation point locations 701 . . . 704 refers to the location and features obtained from decision surface 1. Operation point locations 705 . . . 708 refer to the location and features obtained from decision surface 2. It is noted that only nodes corresponding to two decision surfaces are shown in FIG. 7 for sake of brevity and clarity. The attributes themselves have been split into two types 709 . . . 712 and 713 . . . 716. Here again multiple such types of attributes may be added to the network. An appropriate inferencing algorithm from the many exact and approximate inferencing algorithms may be chosen to arrive at probabilistic estimates for the values for each of the attributes. These estimates are then compared to preset thresholds to generate appropriate alarms in step 408 of FIG. 4. In an alternative embodiment, a Bayesian network may be used to aggregate the location and movement characteristic information obtained from all the decision surfaces.

FIG. 8 illustrates an example of a system to apply the techniques of the present invention in accordance with an embodiment of the present invention. While FIG. 8 illustrates an oil rig system 800, the principles of the present invention may be applied to other systems.

Referring to FIG. 8, oil rig 800 is fitted with multiple sensors, such as top drive encoder 801, top drive torque sensor 802, standpipe pressure gauge 803, hook load sensor 804, drawworks sensor 805, volumeric sensors 806A-806B, pressure sensor 807, velocity sensor 808, flow meter sensor 809, pump 1 strokes sensor 810, pump 2 strokes sensor 811, pump 3 strokes sensor 812 and volumetric pit sensor 813, to monitor oil rig 800. The data is aggregated at the rig and then relayed through some means, such as cables or satellite, to a remote monitoring center. The data (the system operation data) is compared over a period of time to the modeled data. The results of the comparison may then be represented on one or more of the created process maps as discussed above in connection with FIG. 2.

The methodology described in FIGS. 2, 3, 4, 5A-5C, 6A-6C and 7 may be applied to the data thus aggregated to determine attributes, such as the type of drilling operation (reaming, tripping, sliding, etc.,) or hazardous/non-productive events (e.g., lost circulation, kicks, stuck pipes, etc.,) or failing equipment (e.g., top drive, blow out preventers, etc.) to increase safety and efficiency at these rigs.

FIG. 9 illustrates an example of multiple systems (e.g., multiple oil rigs) sending data to a central depository, where the operator in the decision support system is informed of any system that requires attention and/or intervention in accordance with an embodiment of the present invention. Referring to FIG. 9, data from oil rigs 901 . . . 904 may be transmitted to a central data storage server 905, where the methodologies described in FIGS. 2, 3, 4, 5A-5C, 6A-6C and 7 may be applied. The results of such an analysis may be displayed to drilling engineers sitting in a decision support center 906, giving them guidance on the wells that are critical that need to be monitored more carefully from a larger set of wells. For example, the process maps, the decision surfaces, the identified attributes, the operating points, the predicted movement of the operating points and the alarms (all discussed above) may be visually represented to the drilling engineers to assist them in real-time monitoring and operation of the oil rigs. Such attributes may include an operational state, where it is probabilistically determined that the operational state of the oil rig is being entered, ongoing or being exited. Furthermore, such attributes may include an event, where it is probabilistically determined that the event has occurred, is occurring or will occur.

While the principles of the present invention have been applied to a physical system, such as an oil rig, other applications could include monitoring the operation of manned or unmanned vehicles, such as ground vehicles, air vehicles, underwater vehicles and space shuttles. Even within a system, such as an oil rig, the methodology may be applied on individual subsystems, such as top drives, blow out preventers, generators, etc., separately and independently of other subsystems within the system. Other application domains include, for example, human health monitoring, industrial process monitoring and weather monitoring.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for presenting attributes of interest in a physical system, the method comprising:
identifying an attribute of the physical system;
creating a decision surface using one or more of a plurality of process maps, wherein the one or more of the plurality of process maps are representative of system operational data from a plurality of sensors;
identifying a location and a movement characteristic of a current operating point, wherein the current operating point represents values of variables represented by one or more decision surfaces;
using the location and movement characteristic to identify an attribute with a probabilistic value assigned to the attribute;
generating a final probabilistic value for the identified attribute, wherein the final probabilistic value is obtained from weighting and combining probabilistic values;
generating an alarm in response to the final probabilistic value for the identified attribute crossing a threshold; and
visually representing, by a processor, the one or more of the plurality of process maps, the one or more decision surfaces, the identified attribute, the current operating point, a predicted movement of the current operating point, and the alarm in a data handling system to assist an operator in real-time monitoring and operation of the physical system.

2. The method as recited in claim 1 further comprising:
creating process maps modeling the physical system;
modeling predefined operational states using the created process maps;
storing the created process maps as probability tables of modeled data between a first operational variable and other operational variables;
receiving system operation data from the physical system, wherein the system operational data comprises operational variables, wherein the system operation data is received from the plurality of sensors;
comparing the system operation data over a period of time to the modeled data; and
representing results of said comparison on at least one of the created process maps.

3. The method as recited in claim 1, wherein the decision surface visually represents a range of data indicating the identified attribute, wherein the movement characteristic displays visually in a multi-dimensional space the predicted movement of the current operating point in relation to at least one of a plurality of decision surfaces or at least one of the plurality of process maps.

4. The method as recited in claim 1 further comprising:
combining location and movement characteristics from a plurality of decision surfaces to make probabilistic predictions on each of a plurality of attributes.

5. The method as recited in claim 1, wherein the physical system comprises an oil rig and the identified attribute comprises an operational state of the oil rig, wherein the method further comprises:
determining probabilistically that the operational state is being entered, ongoing or being exited.

6. The method as recited in claim 1, wherein the physical system comprises an oil rig and the identified attribute comprises an event, wherein the method further comprises:
determining probabilistically that the event has occurred, is occurring or will occur.

7. The method as recited in claim 1, wherein the physical system comprises an oil rig and the identified attribute comprises an operational state, wherein the method further comprises:
ranking alarms generated from a plurality of oil rigs in terms of criticality so as to identify one or more of the plurality oil rigs that need attention.

8. A computer program product embodied in a computer readable storage medium for presenting attributes of interest in a physical system, the computer program product comprising the programming instructions for:
identifying an attribute of the physical system;
creating a decision surface using one or more of a plurality of process maps, wherein the one or more of the plurality of process maps are representative of system operational data from a plurality of sensors;
identifying a location and a movement characteristic of a current operating point, wherein the current operating point represents values of variables represented by one or more decision surfaces;
using the location and movement characteristic to identify an attribute with a probabilistic value assigned to the attribute;
generating a final probabilistic value for the identified attribute, wherein the final probabilistic value is obtained from weighting and combining probabilistic values;
generating an alarm in response to the final probabilistic value for the identified attribute crossing a threshold; and
visually representing the one or more of the plurality of process maps, the one or more decision surfaces, the identified attribute, the current operating point, a predicted movement of the current operating point, and the alarm in a data handling system to assist an operator in real-time monitoring and operation of the physical system.

9. The computer program product as recited in claim 8 further comprising the programming instructions for:
creating process maps modeling the physical system;
modeling predefined operational states using the created process maps;
storing the created process maps as probability tables of modeled data between a first operational variable and other operational variables;
receiving system operation data from the physical system, wherein the system operational data comprises operational variables, wherein the system operation data is received from the plurality of sensors;
comparing the system operation data over a period of time to the modeled data; and
representing results of said comparison on at least one of the created process maps.

10. The computer program product as recited in claim 8, wherein the decision surface visually represents a range of data indicating the identified attribute, wherein the movement characteristic displays visually in a multi-dimensional space the predicted movement of the current operating point in relation to at least one of a plurality of decision surfaces or at least one of the plurality of process maps.

11. The computer program product as recited in claim 8 further comprising the programming instructions for:
combining location and movement characteristics from a plurality of decision surfaces to make probabilistic predictions on each of a plurality of attributes.

12. The computer program product as recited in claim 8, wherein the physical system comprises an oil rig and the identified attribute comprises an operational state of the oil rig, wherein the computer program product further comprises the programming instructions for:
determining probabilistically that the operational state is being entered, ongoing or being exited.

13. The computer program product as recited in claim 8, wherein the physical system comprises an oil rig and the identified attribute comprises an event, wherein the computer program product further comprises the programming instructions for:
determining probabilistically that the event has occurred, is occurring or will occur.

14. The computer program product as recited in claim 8, wherein the physical system comprises an oil rig and the identified attribute comprises an operational state, wherein the computer program product further comprises the programming instructions for:
ranking alarms generated from a plurality of oil rigs in terms of criticality so as to identify one or more of the plurality oil rigs that need attention.

15. A system, comprising:
a memory unit for storing a computer program for presenting attributes of interest in a physical system; and
a processor coupled to said memory unit, wherein said processor, responsive to said computer program, comprises:
circuitry for identifying an attribute of the physical system;
circuitry for creating a decision surface using one or more of a plurality of process maps, wherein the one or more of the plurality of process maps are representative of system operational data from a plurality of sensors;
circuitry for identifying a location and a movement characteristic of a current operating point, wherein the current operating point represents values of variables represented by one or more decision surfaces;
circuitry for using the location and movement characteristic to identify an attribute with a probabilistic value assigned to the attribute;
circuitry for generating a final probabilistic value for the identified attribute, wherein the final probabilistic value is obtained from weighting and combining probabilistic values;
circuitry for generating an alarm in response to the final probabilistic value for the identified attribute crossing a threshold; and
circuitry for visually representing the one or more of the plurality of process maps, the one or more decision surfaces, the identified attribute, the current operating point, a predicted movement of the current operating point, and the alarm in a data handling system to assist an operator in real-time monitoring and operation of the physical system.

16. The system as recited in claim 15, wherein the processor further comprises:
circuitry for creating process maps modeling the physical system;
circuitry for modeling predefined operational states using the created process maps;
circuitry for storing the created process maps as probability tables of modeled data between a first operational variable and other operational variables;
circuitry for receiving system operation data from the physical system, wherein the system operational data comprises operational variables, wherein the system operation data is received from the plurality of sensors;
circuitry for comparing the system operation data over a period of time to the modeled data; and
circuitry for representing results of said comparison on at least one of the created process maps.

17. The system as recited in claim 15, wherein the decision surface visually represents a range of data indicating the identified attribute, wherein the movement characteristic displays visually in a multi-dimensional space the predicted movement of the current operating point in relation to at least one of a plurality of decision surfaces or at least one of the plurality of process maps.

18. The system as recited in claim 15, wherein the processor further comprises:
circuitry for combining location and movement characteristics from a plurality of decision surfaces to make probabilistic predictions on each of a plurality of attributes.

19. The system as recited in claim 15, wherein the physical system comprises an oil rig and the identified attribute comprises an operational state of the oil rig, wherein the processor further comprises:
circuitry for determining probabilistically that the operational state is being entered, ongoing or being exited.

20. The system as recited in claim 15, wherein the physical system comprises an oil rig and the identified attribute comprises an event, wherein the processor further comprises:
circuitry for determining probabilistically that the event has occurred, is occurring or will occur
